(19) United States
(12) Patent Application Publication
(10) Pub. No.: US 2009/0189116 A1
(43) Pub. Date: Jul. 30, 2009

(54) LIQUID RELEASE AGENT

(75) Inventor: Bernd Riepe, Bunde (DE)

Correspondence Address: HENRY M FEIEREISEN, LLC;HENRY M FEIEREISEN, 708 THIRD AVENUE, SUITE 1501, NEW YORK, NY, 10017, US

(73) Assignees: Angelika Riepe, Bunde (DE); Hans Riepe, Bunde (DE)

(21) Appl. No.: 12/361,205

(22) Filed: Jan. 28, 2009

(30) Foreign Application Priority Data
Jan. 29, 2008 (DE) 10 2008 006 614.1

(51) Int. Cl. C09K 3/00

(52) U.S. Cl. 252/182.12

(57) ABSTRACT

A liquid release agent for application onto an edge region of a panel, which edge region is provided or to be provided with a coating by means of an adhesive or by means of a glue, includes a fluidic carrier made of alcohol, or a mixture of alcohols, or a mixture of hydrocarbons, or a mixture of solvents, and polyalkylene glycol which is admixed to the carrier.

### CROSS-REFERENCES TO RELATED APPLICATIONS

This application claims the priority of German Patent Application, Serial No. 10 2008 006 614.1, filed Jan. 29, 2008, pursuant to 35 U.S.C. 119(a)-(d), the content of which is incorporated herein by reference in its entirety as if fully set forth herein.

### BACKGROUND OF THE INVENTION

The present invention relates, in general, to a liquid release agent for application onto an edge region of a panel, in particular a furniture panel, provided or to be provided with a coating by means of adhesive or glue.

Nothing in the following discussion of the state of the art is to be construed as an admission of prior art.

A release agent of a type involved here may find application to prevent adhesive or glue remnants escaping to the side to stick to a panel such as a furniture panel, when the edge of the furniture panel is coated. Through application of the release agent, subsequent cleaning, e.g. by means of cleansing disks, can easily be carried out. Release agents have been in use which contain solvents that can evaporate and fluidic carriers in the form of mineral oils, e.g. white oil. This type of release agent suffers many shortcomings. As the release agent has a fairly low boiling range or flash point, any application in so-called hot zones in which the panel is heated before bonding an edge strip, becomes problematic especially for safety reasons and for reasons of workplace protection. Practice has also shown that this type of liquid release agent is inadequate for use in so-called soft forming or post forming facilities because the use of mineral oil as carrier adversely affects the production outcome.

The use of a liquid release agent which is made of aqueous alcoholic polyglycol solution has also been proposed for application as lubricant or antiseize agent to reduce friction of a pressure-application tool. Application of such a release agent onto an edge region of a panel, in particular a furniture panel, is however inadequate because the presence of water causes a deposit of chips during cutting and or dust in the edge zone of the panel, when the panel moves through the hot zone. Roller-type tracers positioned anteriorly of the machining tools get very dirty so that the panel can no longer be processed accurately enough. In addition, as water does not sufficiently evaporate in the hot zone, scrubbing brushes used for cleansing the panel after application of the edge coating and subsequent treatment get very wet. As a result, the panel is still moist after being removed from the machinery, causing water edges. Thus, panel quality is diminished and unacceptable and the panels may stick together, when stacked.

It would therefore be desirable and advantageous to provide an improved liquid release agent to obviate prior art shortcomings.

### SUMMARY OF THE INVENTION

According to one aspect of the present invention, a liquid release agent includes a fluidic carrier made of a material selected from the group consisting of alcohol, a mixture of alcohols, mixture of hydrocarbons, and mixture of solvents, and polyalkylene glycol admixed to the carrier.

The present invention resolves prior art problems by providing a liquid release agent which has a water-free fluidic carrier for the polyalkylene glycol component. The alcohol or the mixture of alcohol, or of hydrocarbons, or solvents have each a high evaporation rate so that polyalkylene glycol will ultimately adhere to the panel surface in the wetted zones, with the polyalkylene glycol exhibiting great affinity to plastic surfaces. In addition, the boiling point of polyalkylene glycol or its flash point is above the one of mineral oil so that a liquid release agent according to the invention is applicable in particular for use in hot zones, thereby significantly enhancing its range of applications. A liquid release agent according to the invention can also be used in soft forming or post forming facilities. In fact, a liquid release agent according to the invention may be considered universally applicable, thereby providing substantial economic benefit. Refinishing becomes easier and can be implemented at high quality. Waste rate of panels being processed is hereby significantly reduced.

According to another advantageous feature of the present invention, the polyethylene glycol may involve polyethylene glycol having a general formula HO(CH₂CH₂O)ₙH with a mean molar mass of about 200 to 12,000 g/mol, polypropylene glycol having a general formula HO(CHCH₃CH₂O)ₙH with a mean molar mass of about 600 to 4,000 g/mol, and/or a copolymerisate of propylene oxide and/or ethylene oxide with a mean molar mass of about 1,000 to 8,000 g/mol.

According to another advantageous feature of the present invention, polyalkylene glycol may be present at a fraction of ≧1% by volume.

According to another advantageous feature of the present invention, polyalkylene glycol is present at a fraction of ≦20% by volume.

According to another aspect of the present invention, a method includes the steps of admixing polyalkylene glycol to a fluidic carrier made of alcohol, a mixture of alcohols, a mixture of hydrocarbons, or a mixture of solvents to produce a liquid release agent; and applying the release agent onto an edge region of a panel, which edge region has a coating of an adhesive or glue.

### BRIEF DESCRIPTION OF THE DRAWING

None

### DETAILED DESCRIPTION OF PREFERRED EMBODIMENTS

None

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A liquid release agent, comprising:
a fluidic carrier made of a material selected from the group consisting of alcohol, a mixture of alcohols, mixture of hydrocarbons, and mixture of solvents, and
polyalkylene glycol admixed to the carrier.

2. The release agent of claim 1, wherein the polyalkylene glycol is at least one member selected from the group consisting of polyethylene glycol having a general formula HO(CH₂CH₂O)ₙH with a mean molar mass of about 200 to 12,000 g/mol, polypropylene glycol having a general formula HO(CHCH₃CH₂O)ₙH with a mean molar mass of about 600 to 4,000 g/mol, and a copolymerisate of at least one oxide selected from the group consisting of propylene oxide and ethylene oxide with a mean molar mass of about 1,000 to 8,000 g/mol.

3. The release agent of claim 1, wherein the polyalkylene glycol is present at a fraction of ≧1% by volume.

4. The release agent of claim 1, wherein the polyalkylene glycol is present at a fraction of ≦20% by volume.

5. The release agent of claim 1 for application onto an edge region of a panel, which edge region is provided or to be provided with a coating by means of an adhesive or by means of a glue.

6. The release agent of claim 1, wherein the panel is a furniture panel.

7. The release agent of claim 1, wherein the fluidic carrier contains volatile hydrocarbons.

8. A method, comprising the steps of:
admixing polyalkylene glycol to a fluidic carrier made of a member selected from the group consisting of alcohol, a mixture of alcohols, a mixture of hydrocarbons, and a mixture of solvents to produce a liquid release agent; and
applying the release agent onto an edge region of a panel, which edge region has a coating of an adhesive or glue.
